(19) United States
(12) Patent Application Publication
(10) Pub. No.: US 2007/0129275 A1
(43) Pub. Date: Jun. 7, 2007

(54) Bucketless Carwash Composition

(76) Inventors: Hida Hasinovic, Lexington, KY (US); Frances E. Lockwood, Georgetown, KY (US); Elsie Jordan, Temecula, CA (US); Wen-Chen Su, Lexington, KY (US); Michael A. Dituro, Huntington, WV (US); Meghan A. Kane, Wilder, KY (US)

Correspondence Address: JAMES M. FRANCIS, 300 W VINE ST, STOLL KEENON OGDEN PLLC, LEXINGTON, KY, 40507, US

(21) Appl. No.: 11/164,773

(22) Filed: Dec. 5, 2005

(51) Int. Cl. C11D 3/37

(52) U.S. Cl. 510/189; 510/424; 510/475

(57) ABSTRACT

A novel car wash composition that significantly reduces water spotting, redeposition of soil, and inhibits the formation of hard water scale. The novel car wash composition is comprised of: a substantive polymer to render the painted surface of the car more hydrophilic, a surfactant package containing a mixture of anionic and non-ionic surfactants selected to optimize the benefits of the substantive polymer, and various fragrances, dyes, and biocides commonly found in car wash compositions.

### BACKGROUND

1. Field of the Invention

The present invention relates to a cleaning composition. More specifically, the present invention relates to car wash compositions and more specific still, car wash compositions which do no require dilution into larger quantities of water but which may be sprayed directly onto a vehicle.

2. Problems in the Art

Many types of car wash compositions are commercially available in the marketplace. These car wash compositions typically include detergents and surfactants and have been known to include polymers to render a surface more hydrophilic.

These conventional car washes function by lifting dirt away from the surface, suspending as much as possible in the car wash/water mixture, and removing the dirt from the washed vehicle as a water rinse is applied. Additional wiping with a terry cloth or chamois is often required to attempt to remove the dirt that fell out of suspension or that was never suspended initially.

The hardness of the water can also affect the effectiveness of the car wash composition. Excessive concentrations of calcium, magnesium and other minerals can form water spots as beads of water dry on the surface of the vehicle. This will often require additional wiping of the car surface to remove these unsightly deposits.

Wiping a car surface multiple times to remove dirt which fell out of suspension and to remove water spots can significantly impact the time required to wash a car. Areas of the car surface can also be overlooked upon wiping, thus dirt and water spots remain and dissatisfaction with the car wash composition can impact the consumer's choice as to their next purchase and harm the reputation of the manufacturer.

U.S. Pat. No. 5,759,980, Car Wash by Russo et al. (Jun. 2, 1998) describes a car wash composition that utilizes a detergent, surfactants, and a polymer to make a car surface more hydrophilic. However, the Russo invention fails to provide for dirt suspension and also fails to inhibit redeposition of soils. The Russo invention also fails to utilize a novel polymer system that was unavailable until recently. Additionally, the '980 patent utilizes poly(vinylpyrrolidone/acryilic) acid polymers with an average molecular weight in the range of 100,000 to 2,000,000 wherein the present invention utilizes polymers of substantially lower average molecular weight.

### SUMMARY OF THE INVENTION

The present invention is a novel car wash composition comprising a unique blend of anionic surfactants with a novel high molecular weight polymer in combination with water, fragrances, dyes, and detergents.

This novel composition produces significant reductions in water spotting and in the dispersion of soil and other constituents of dirt from the surface of vehicles when compared to commercially available car wash compositions. This composition also allows for the elimination of hand drying. The novel composition is particularly useful when prediluted and applied directly to the car surface, thus eliminating the step of dilution an the need for a bucket.

### DETAILED DESCRIPTION OF THE INVENTION

The novel car wash is composed of a first anionic surfactant to aid in the production of foam, a second anionic surfactant, a non-ionic surfactant selected from the group consisting of fatty acid alkanolamides, a detergent, and a low molecular weight substantive polymer to render the surface to be cleaned more hydrophilic and which inhibits ortho-phosphate scale production.

Anionic Surfactants

Anionic surfactants are well known to those skilled in the art as materials useful in both removal and suspension of soil. A surfactant is generally defined as any compound which reduces the surface tension of liquids, or reduces interfacial tension between two liquids, or a liquid and a solid. Surfactants often comprise two segments, one segment which is hydrophilic and another which is hydrophobic. Surfactants are used to improve wetting; provide detergency by solublizing and suspending soils; produce, modify or control foam, to create emulsions or dispersions, couple or compatibilize formulation components; and to modify viscosity.

The ability of anionic surfactants to reduce the surface tension of water results in water spreading out over a larger surface rather than forming beads. This is referred to as wetting. This is important because the remaining suspended soil and particulates will be spread out over a larger area and the appearance of water spots will be minimized as the remaining wash water and rinse water evaporates instead of being wiped or drained from the washed surface.

An anionic surfactant is a surfactant with a negatively charged surface-active ion. These anionic surfactants can be broadly categorized into soaps (fatty acid salts) and detergents. Typically anionic surfactants are accompanied by non-ionic surfactants as a means for stabilizing a mixture containing anionic surfactants.

Anionic surfactants tend to form more foam than nonionic and cationic surfactants. The production of foam is imperative for sufficient lubrication and to assist in particulate suspension. Anionic surfactants are very effective in removing particulate and oily soils. Being negatively charged, the anion forms an insoluble complex with calcium and magnesium cations in hard water.

Detergents are often used instead of soaps as anionic surfactants due to their resistance to precipitating in low pH solutions. A commonly used anionic surfactant is sodium dodecyl sulfate (SDS). Other commonly used anionic surfactants are the alkyl benzenesulfonates, alkyl sulfonates and the alkyl phosphates. Sulfosuccinates are similar to the alkyl sulfonates and were developed in 1939. Additional examples of anionic surfactants include organic carboxylates, organic sulfonates, organic sulfates, organic phosphates and the like, particularly linear alkylaryl sulfonates, such as alklylarylcarboxiylates, alkylarylsulfonates, alkylarylphosphates, and the like. It has been found that only certain anionic surfactants maximize the benefits of the present invention. A preferred family of anionic surfactants is olefin sulfonates, particularly sodium alpha olefin sulfonates.

A second preferred family of anionic surfactants are sulfates of ethoxilated alcohols, and more specifically an alkyl ether sulfate ammonium salt. The ethoxilated alkyl sulfates are prepared by sulfating ethoxilated alcohols and their chemical structure is: [RO(CH2CH2O)ₓ(CH2CH2O)(SO3)⁻]M⁺; wherein R is a straight chain saturated organic compound containing 12-18 carbon atoms; M is a cation being sodium, potassium, ammonium or an alkyloamine compound; and x is an integer from 1 to 5.

The degree of ethoxilation can wary from 1 to 5 ethylene oxide units. These surfactants are usually used as oil in water emulsifier and cleansing agents in cleaners and shampoos. Their cleaning performance is closely related to their chain length and the type of cation.

These surfactants are usually used as oil in water emulsifiers and cleansing agents in cleaners and shampoos. Their cleaning performance is closely related to their chain length and the type of cation.

Nonionic Surfactants

Nonionic surfactants differ from both cationic and anionic surfactants, although their function remains the same, in that the molecules are actually uncharged. The hydrophilic group is made up of some other very water soluble moeity, (e.g. a short, water-soluble polymer chain) rather than a charged species. Traditionally, nonionic surfactants have used poly(ethylene oxide) chains as the hydrophilic group. Poly(ethylene oxide) is a water soluble polymer; the polymers used in nonionic surfactants are typically 10 to 100 units long.

Non-limiting examples of commonly used non-ionic surfactants include alkyl polysaccharides, alklyamine ethoxylates, amine oxides, block copolymers, castor oil ethoxylates, ceto-oleyl alcohol ethoxylates, ceto-stearyl alcohol ethoxylates, decyl alcohol ethoxylates, dinonyl phenol ethoxylates, dodecyl phenol ethoxylates, end-capped ethoxylates, ethoxylated alkanolamides, ethylene glycol esters, fatty acid alkanolamides, fatty alcohol alkoxylates, lauryl alcohol ethoxylates, mono-branched alcohol ethoxylates, nonyl phenol ethoxylates, octyl phenol ethoxylates, random copolymer alkoxylates, sorbitan ester ethoxylates, stearic acid ethoxylates, synthetic alcohol ethoxylates, tall oil fatty acid ethoxylates, and tallow amine ethoxylates. It has been found that only certain non-ionic surfactants maximize the benefits of the present invention.

Preferred non-ionic surfactants used in the present invention are the fatty acid alkanolamides. More preferred are the fatty acid alkanolamides that contain glycerin. Most preferred is a vegetable oil based amide wherein the structure is: 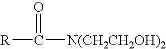
wherein R is a vegetable oil.

Substantive Polymer

The critical step of improving wetting and preventing redeposition of soil and scale is accomplished in large part by the chosen substantive polymer. The washed surface is made hydrophilic, or water loving, so that the remaining water “sheets out” into a thin film rather than forming spheroid shaped droplets. This also promotes the draining of the surface in “sheet form” rather than by the formation of rivulets. When water collects in droplets and drains as rivulets, the soil and scale carried by the water passes over a relatively small surface area when compared to sheeting. Therefore, if any redeposition occurs it will be more likely to be noticeable due to a higher concentration of deposits over a small surface area, rather than spreading out the contaminants over the wider surface area involved in sheeting.

The more effective the polymer, the greater the sheeting action, the greater the quantity of soil and scale may be suspended, and the longer the time that soil and scale can be suspended. Ideally the substantive polymer will inhibit the production of calcium and magnesium scale from “hard” water, especially ortho-phosphate scales that are difficult to inhibit. Ortho-phosphate scales develop under medium and hard water conditions by binding with phosphate salts present in the cleaning formulation to form a hard, precipitate scale. Sulfonated copolymers function to break up crystals of mineral scale, even orth-phosphate scale, and re-disperse them into solution thus functioning as both a dispersant and a scale-remover. The ideal polymer will also serve to bolster the function of anionic surfactants by helping to keep oily, fatty, and greasy soils dispersed and suspended.

A commonly used polymer found in cleaning applications is a sulfonated polystyrene. The styrene end of the polymer functions to make the surface more hydrophilic. Other non-limiting examples of commonly used polymers include

The substantive polymer of the present invention is preferably a sulfonated polymer. More preferably the substantive polymer is a sulfonated acrylate copolymer. The average molecular weight of the preferred is less than about 100,000, more preferably less than about 50,000, and most preferably less than about 20,000.

Surfaces to be Washed

The present invention may be used on virtually any non-porous surface. While primarily intended for use on painted metal surfaces, the present invention will find many uses to clean plastic, rubber, and other materials associated with the exterior of an automobile. Additionally, the present invention will find many uses to clean boats, campers, mobile homes, recreational vehicles, motorcycles, outdoor furniture, or almost any article of manufacture designed for the outdoors.

Techniques of Application

The present invention is intended to be diluted in an appropriate volume of water. De-mineralized water is preferred so that water spotting can be minimized, but is not required to reap the advantages of the novel composition. The present invention is stable enough to be prediluted in a spray bottle or other commonly utilized means for commercial packaging. The common step of diluting a car wash in a bucket or other sufficiently large container at the time of washing is not required with the present invention since the novel composition is so effective at suspending particulates that constant rinsing is not required.

Ideally the present invention is sprayed on to a vehicle surface. Application may be to the entire vehicle or to specific locations for spot cleaning. Upon wiping, the soil and other surface contaminants are loosened and agitated thus becoming suspended within the mixture of water and the novel composition.

Anti-Redeposition Tests

At preselected times, 5 ml samples were extracted from the center of the graduated cylinder and then dried and weighed. As expected the novel composition of the present invention was able to keep a larger quantity of particulates in suspension than similar commercially available products.

The quantitative procedure utilized for the aforementioned anti-redeposition test was as follows:

One (1) gram of sample car wash was placed in a 100 ml graduated cylinder. One (1) gram of ground dirt was then added to the graduated cylinder containing the car wash. Ninety-eight (98) grams of tap water was then added to the aforementioned graduated cylinder. The cylinder was then inverted 10 consecutive times to promote mixing of the contents. Five (5) gram samples were removed from the middle of each sample for solids testing on a pre-determined schedule and results recorded. The solids testing entailed drying and weighing the extracted sample to reach a quantitative determination as to the mass of particulates remaining. The test was rerun using 2.00 grams of each car wash, resulting in 1.8 mass percent car wash composition in solution. The results are described by Table 1 and Table 2. The present invention, identified as BUCKET FREE™, compared favorably with similar products from ARMOR ALL™ and MOTHER'S™ in that it was able to keep dirt in suspension much longer, thus making the wash more effective.

TABLE 1
Mass of Suspended Particulates Recovered

| | 1 gram Sample of Car Wash | | |
|---|---|---|---|
| | ARMOR ALL ™ | MOTHER'S TRIGGER | BUCKET |
| | grams | WASH ™ | FREE ™ |
| Hours | suspended | grams suspended | grams suspended |
| 0.0 | 0.0373 | 0.0494 | 0.0554 |
| 0.5 | 0.0067 | 0.0112 | 0.0154 |
| 2.0 | 0.0032 | 0.0047 | 0.0067 |
| 3.0 | 0.0025 | 0.0038 | 0.0062 |

TABLE 2
Mass of Suspended Particulates Recovered

| | 2 gram Sample of Car Wash | | |
|---|---|---|---|
| | ARMOR ALL ™ | MOTHER'S TRIGGER | BUCKET |
| | grams | WASH ™ | FREE ™ |
| Hours | suspended | grams suspended | grams suspended |
| 0.0 | 0.0959 | 0.0424 | 0.2116 |
| 0.5 | 0.0117 | 0.0101 | 0.0876 |
| 2.0 | 0.0086 | 0.0081 | 0.0628 |
| 3.0 | 0.0077 | 0.0074 | 0.0585 |

Measurement of the transmittance of light through prepared samples provided another quantitative measurement of the effectiveness of the present invention in an anti-redeposition test. Samples were prepared by placing 0.10 g of sample car wash in a 25 ml graduated cylinder to which 1.00 g of ground dirt and 25.00 g of DI water was subsequently added. Blanks were created by replacing the dirt with the equivalent mass of DI water.

Samples were tested at regular intervals, as demonstrated in the following example, for percent transmittance of light with a wavelength of 700 nm. Suspended particulates would be expected to block the radiation as it passes through the sample. Each sample's contribution to the reduction in transmittance was measured and accommodated for by background cancellation using standard spectroscopic methods. As can be demonstrated by the following table, the present invention provided superior suspension of particulates when compared to commercially available car washes.

The present invention, identified as BUCKET FREE™, compared favorably with similar products from ARMOR ALL™ and MOTHER'S™ in that it was able to keep dirt in suspension much longer, as evidenced by how little light was successfully transmitted through the sample, thus making the wash more effective by keeping more dirt in suspension awaiting rinsing and removal. The results are described in Table 3.

TABLE 3
Percent Transmittance of Light (700 nm − 1)as
a Means to Measure Suspended Solids

| | | MOTHER'S TRIGGER | BUCKET |
|---|---|---|---|
| | ARMOR ALL ™ | WASH ™ | FREE ™ |
| Minutes | % Transmit. | % Transmit. | % Transmit. |
| 0.0 | 4.2 | 6.4 | 3.2 |
| 0.5 | 4.8 | 7.8 | 3.2 |
| 1.0 | 5.6 | 9.8 | 3.4 |
| 1.5 | 6.6 | 11.8 | 3.6 |
| 2.0 | 7.2 | 13.4 | 3.6 |
| 2.5 | 7.8 | 15.0 | 3.6 |
| 3.0 | 8.4 | 16.4 | 3.8 |
| 3.5 | 9.0 | 17.6 | 3.8 |
| 4.0 | 9.4 | 19.0 | 3.8 |
| 4.5 | 10.0 | 20.0 | 4.0 |
| 5.0 | 10.4 | 20.8 | 4.0 |
| 5.5 | 10.8 | 21.2 | 4.0 |
| 6.0 | 11.4 | 21.8 | 4.0 |
| 6.5 | 11.8 | 23.4 | 4.2 |
| 7.0 | 12.2 | 24.4 | 4.2 |
| 7.5 | 12.6 | 25.2 | 4.2 |
| 8.0 | 13.0 | 27.8 | 4.2 |
| 8.5 | 13.4 | 29.8 | 4.2 |
| 9.0 | 13.6 | 30.0 | 4.4 |
| 9.5 | 14.0 | 30.2 | 4.4 |
| 10.0 | 14.2 | 34.2 | 4.4 |
| 15.0 | 19.0 | 36.8 | 4.8 |
| 20.0 | 23.0 | 42.0 | 5.2 |
| 25.0 | 24.6 | 43.4 | 5.6 |
| 30.0 | 27.4 | 45.6 | 5.8 |

Water-Spot Testing

Painted metal test panels were cleaned using subject car washes. The test panels were then gently rinsed with tap water until all visible soap was removed. The panels were subsequently air dried at pre-determined angles of 79.5°, 30.3° and 0°. A transparent grid was then placed over the dried panels and an approximate surface area covered by water spots, described as a water spot index, and location of water spots were recorded. Each car wash sample was tested once on each of three panels and the results averaged.

The novel car wash composition of the present invention provided a significant reduction in water spotting from scale and redeposition of particulates. The present invention also kept soil in suspension and in greater amounts than other compositions tested. Table 4 demonstrates the ability of the novel composition of the present invention to reduce the formation of water spots when compared to commercially available car washes.

TABLE 4
Water Spot Index Measured from a Painted
Metal Panel at Various Inclinations

| | ARMOR | MOTHER'S TRIGGER | BUCKET |
|---|---|---|---|
| Inclination | ALL ™ | WASH ™ | FREE ™ |
| 0.0 | 56 | 109 | 9 |
| 30.3 | 45 | 52 | 4 |
| 79.5 | 32 | 42 | 1 |

What is claimed is:

1. A car wash composition comprising:
a surfactant package, from about 1 to 80% of the composition mass, containing at least one surfactant selected from the group consisting of anionic surfactant, non-ionic surfactant or mixtures thereof; a polymer package from about 0.01 to about 10% of the composition mass, containing at least one substantive polymer capable of bonding with a surface to provide improved hydrophilicity, having a molecular weight from about 5,000 to about 95,000; and from about 10 to about 95% water.

2. The composition of claim 1, further comprising a dye.

3. The composition of claim 1, further comprising a biocide.

4. The composition of claim 1, further comprising a fragrant material.

5. The composition of claim 1, further comprising an alkalinity source.

6. The composition of claim 1, wherein said at least one surfactant is an anionic surfactant selected from the group consisting of sulfates, sulfonates, disulfonates, and sulfosuccinates.

7. The composition of claim 6, wherein said anionic surfactant is an olefin sulfonate.

8. The composition of claim 7, wherein said olefin sulfonate is a sodium alpha olefin sulfonate.

9. The composition of claim 1, wherein said at least one surfactant is an anionic surfactant selected from the group consisting of sulfates of ethoxylates and sulfates of alkoxylates.

10. The composition of claim 9, wherein said anionic surfactant is an alkyl ether sulfate salt.

11. The composition of claim 10, wherein the alkyl ether sulfate salt contains a cation selected from the group consisting of sodium, potassium, ammonium, and an alkyloamine compound.

12. The composition of claim 10 wherein the alkyl unit of said alkyl ether sulfate salt is a straight chain saturated organic compound containing from about 12 to about 18 carbon atoms.

13. The composition of claim 10, wherein said alkyl ether sulfate salt contains from 1 to 5 ethylene oxide units.

14. The composition of claim 1, wherein said at least one surfactant is a fatty acid alkanolamide non-ionic surfactant.

15. The composition of claim 14, wherein said fatty acid alkanolamide non-ionic surfactant has a glycerin unit.

16. The composition of claim 15, wherein the fatty acid in said fatty acid alkanolamide non-ionic surfactant is derived from a vegetable oil.

17. The composition of claim 1, wherein said substantive polymer is a sulfonate acrylate copolymer.

18. The composition of claim 1, wherein said substantive polymer is a multi-functional polymer commercially available for use in automatic dish washing cleaning compositions.

19. The composition of claim 1, wherein said substantive polymer is selected from the group of multifunctional polymers consisting of ALCOGUARD 4000 and ALCOSPERSE 240.

20. The method of washing a vehicle comprising the following steps: providing a car wash composition of claim 1; wetting the vehicle surface; applying said composition directly to the said vehicle surface; agitating said composition on said surface of said vehicle with an appropriate material for cleaning said vehicle surface; and rinsing said vehicle surface with water.
